(19) United States
(12) Patent Application Publication
(10) Pub. No.: US 2008/0128243 A1
(43) Pub. Date: Jun. 5, 2008

(54) Method for Determining the Exact Center of a Coin Introduced into a Coin Acceptor Unit

(75) Inventors: Manfred Wollny, Berlin (DE); Klaus Spinnler, Erlangen (DE); Andreas Kuleschow, Oberasbach (DE); Robert Couronne, Erlangen (DE)

Correspondence Address: KAPLAN GILMAN GIBSON & DERNIER L.L.P., 900 ROUTE 9 NORTH, WOODBRIDGE, NJ, 07095, US

(73) Assignee: WALTER HANKE MECHANISCHE WERKSTATTEN GMBH & CO. KG, Berlin (DE)

(21) Appl. No.: 11/815,258

(22) PCT Filed: Feb. 3, 2006
(86) PCT No.: PCT/EP06/01122

§ 371 Date: Oct. 11, 2007

(30) Foreign Application Priority Data
Feb. 4, 2005 (DE) 102005006018.8
Feb. 3, 2006 (EP) PCT/EP2006/001122

(51) Int. Cl. G07D 5/00

(52) U.S. Cl. 194/328

(57) ABSTRACT

A method for determining an exact centre of a coin introduced into a coin acceptor unit, the method comprising: determining a probable centre of the coin by means of a sensor arrangement; recording an image of the coin to be examined; and developing an edge region of the coin around the probable centre and beyond a probable edge thereof using the image of the coin, the edge region of the coin being imaged as an at least approximately sinusoidal line upon displacement of the probable centre to the exact centre, and the exact centre being determined from analysis of the at least approximately sinusoidal line using an amplitude and phase angle of a chosen starting point.

### BACKGROUND

The invention relates to a method for determining the exact centre of a coin introduced into a coin acceptor unit according to the preamble of the main claim.

A method for detecting coins is known from WO 2004/075124 A1, in which the image of a coin is recorded by an image sensor. In order to determine the size of the recording region, i.e. the overlapping region of the image sensor by the coin, the diameter of the coin is determined by scanning the vertex by means of a column of the image sensor. In the known prior art, the speed is calculated by scanning the front edge on a line in the centre of the coin in order to determine in addition the time. At the overlapping region, the image of the coin is recorded, recognition of the embossing or pattern being implemented in a further processing step. This pattern recognition is based on analysis of a transformed image of the coin in which the circular area or approximate circular area of the coin is developed by 360° around the centre. It is thereby important that the exact centre is known since an imprecise definition of the centre directly affects the reproducibility of the mentioned evaluation process. It has been shown that the detection of the centre corresponding to the mentioned prior art is not sufficiently exact.

### SUMMARY OF THE INVENTION

The object therefore underlying the invention is to produce a method for determining the exact centre of a coin introduced into a coin acceptor unit, which, starting from detection of the probable centre corresponding to the known state of the art, determines the exact centre without particularly great evaluation complexity.

This object is achieved according to the invention by the characterising features of the main claim in conjunction with the features of the preamble.

Advantageous developments and improvements are possible as a result of the measures indicated in the sub-claims.

As a result of the fact that a development of the edge region of the coin is undertaken around the probable centre and beyond the probable edge thereof, an image of the edge as an at least approximately sinusoidal line is produced upon displacement of the probable centre to the exact centre, the exact centre being able to be determined from the analysis of the at least approximately sinusoidal line using the amplitude and the phase angle of a chosen starting point. Therefore with low computing complexity, the precise determination of the centre can therefore be undertaken by a reduced transformation of the edge region beyond the probable edge.

Advantageously, the size of the deviation or of the offset between probable centre and exact centre is determined from the difference of the greatest and smallest amplitude, the phase angle of the offset is determined as the average of the phase angle of the greatest amplitude and of the phase angle of the counter-direction to the smallest amplitude. The exact radius of the coin is determined as the sum of the inner radius of the edge region and the average of the smallest and greatest amplitude.

The size of the deviation or of the offset and the direction of the offset can also be determined in other ways, if necessary the quality of the sinusoidal line having an influence.

For example, the phase angle can be determined by determining the location of the greatest or the smallest amplitude, the size of the deviation can be determined from the difference of the greatest amplitude at a given phase angle and the amplitude determined at a phase angle of −90° or +90° to the phase angle of the maximum or of the minimum. The exact radius of the coin can be determined as the sum of the inner radius of the edge region and of the amplitude at a phase angle of −90° or +90° to the phase angle of the location of the maximum amplitude.

It is possible to determine the centre with only a part of the image, e.g. with only the upper half of the imaged coin in order to save time for transmission of the image data. The transformed development is thereby only half of the sine function.

Advantageously, the method according to the invention can be applied also in the case of coins with corners or undulations, the sinusoidal line of the edge of the coin and a curve overlapping, the period of said curve representing the number of corners or undulations or the amplitude thereof for the depth of the corners or undulations.

The size of the deviation, the phase angle and the number of undulations or corners of a coin can thereby be determined for example by a Fourier transform of the transformed edge line.

Basically the inventive idea resides in the fact that an essentially sinusoidal curve is produced with the help of a polar transformation from an edge line of the coin, with the analysis of which the centre of the coin is determined in a rapid and exact manner. In addition to the already indicated methods, other known methods can be used to determine the parameters of the edge line.

In addition to the exact calculation form, approximations can be used which provide adequate results for the boundary conditions given by the respective application, such as reproducibility in series production and the like.

Other aspects, features, and advantages of the present invention will be apparent to one skilled in the art from the description herein taken in conjunction with the accompanying drawings.

### BRIEF DESCRIPTION OF THE DRAWINGS

The method according to the invention is explained in more detail in the subsequent description with reference to the drawing. There are shown

FIG. 1 the schematic representation of a coin with the coordinates of a polar transformation about an exact centre A and a probable centre B which is displaced downwards to the right relative to the exact centre,

FIG. 2 the polar transformation of the edge region of the coin a) around the exact centre and b) around the displaced probable centre,

FIG. 3 a coin with an undulating edge contour,

FIG. 4 the development of the edge region of the coin with an exact centre and with a displaced probable centre,

FIG. 5 representation of circles with offset centres in order to explain the form of a transformed edge line.

### DETAILED DESCRIPTION OF THE INVENTION

As was described already with respect to the state of the art of WO 2004/075124, the disclosure content of which is intended to be a component of the application, the centre or the diameter can be determined by the method disclosed there. However the diameter or the centre can also be found by light barriers and sensors. This determination is however not exact enough for pattern recognition by means of image recording and developing the circular area over 360° around the centre, i.e. for a polar transformation. Therefore this centre is described as probable centre. The centre which is actually present during recording of the coin by an image sensor is described as exact centre.

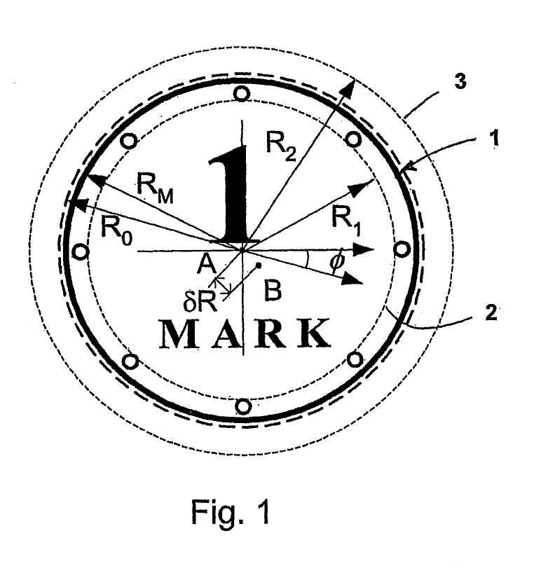

In FIG. 1, a coin 1 with an exact centre A and a centre B which is displaced by δR downwards to the right by approx 45° is represented, these centres being likewise the centres for a polar transformation. For the method according to the invention, starting from the probable centre B and corresponding to the diameter, a polar transformation is undertaken, i.e. a development of the edge region of the coin in which the polar coordinates are converted into Cartesian coordinates.

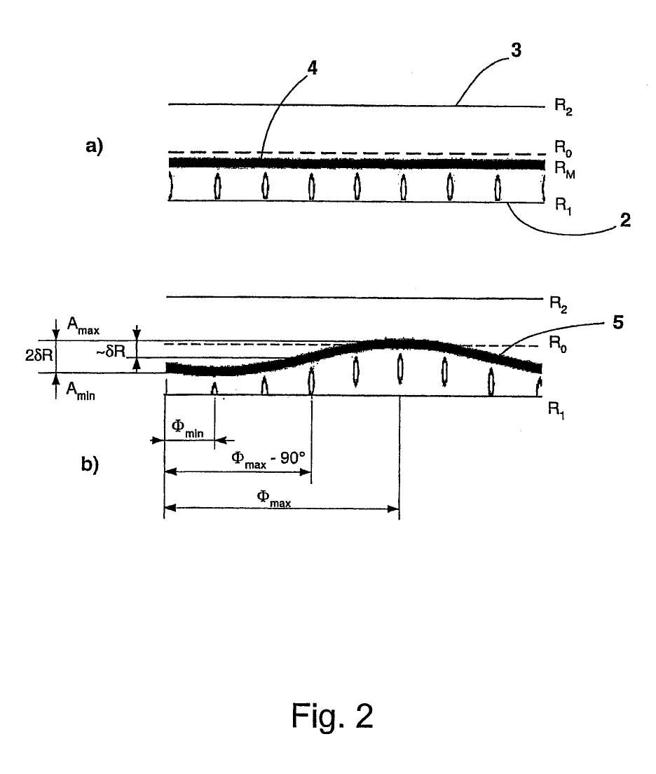

In FIG. 2, on the one hand, the development of the edge region of the coin 1 with an exact centre A and, on the other hand, around the probable centre B displaced by δR is represented. The development, in order to accelerate the transformation, is thereby undertaken such that an edge region is observed which is delimited outwardly by a boundary line 3 with a radius R₂ and inwardly by a boundary line 2 with the radius R₁. The exact radius of the coin 1 is designated with R_{M} and the probable radius with R_{O}, which is determined upon introduction of the coin into the measuring region. The width of the edge region must be chosen such that the coin with the centre displaced by δR is included still within this edge region. There applies therefore for the radii of the edge region

R₁<R_{O}−ΔRₘₐₓ and R₂>R_{O}+ΔRₘₐₓ

ΔRₘₐₓ is thereby the sum of the maximum possible errors when determining the probable centre δRₘₐₓ and when determining the probable radius of the coin dRₘₐₓ:

ΔRₘₐₓ=δRₘₐₓ+dRₘₐₓ

In the case of correspondence of the probable and the exact centre, the edge of the coin 1, in the transformed representation, produces a straight line 4 corresponding to FIG. 2a). In the case of a development with a probable, i.e. displaced centre of the polar transformation, an at least approximately sinusoidal line 5 is produced for the edge (FIG. 2b) which is designated in the following as a sinusoidal line.

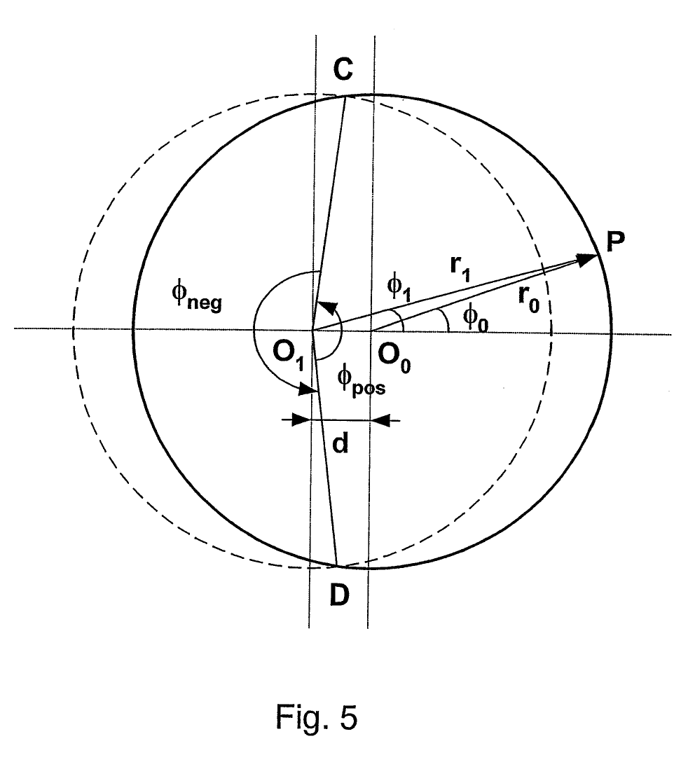

With reference to FIG. 5, the form of the transformed edge line (sinusoidal line 5) is intended to be explained in more detail. In the illustration of FIG. 5, O₁ is the centre of the polar transformation and O₀ is the centre of the coin with a radius r₀. The offset between the transformation centre O₁ and centre O₀ of the coin is d. An edge point of the coin P has the distance r₀ from the centre of the coin and r₁ from the centre of the transformation, the phase angles of which are correspondingly characterised as φ₀ and φ₁.

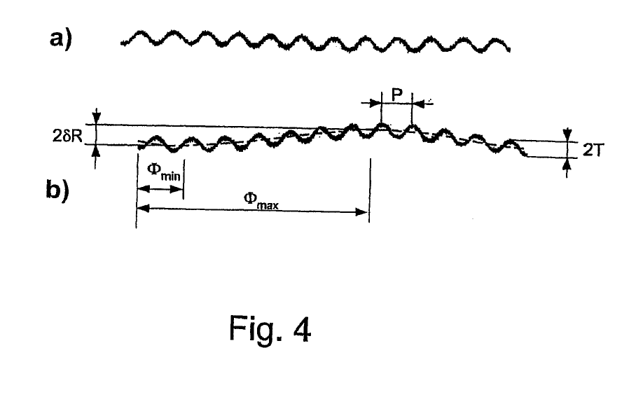

An equation for the distance from the centre of the transformation r₁ (ordinate in the transformed coordinate system of the images FIG. 2 and FIG. 4) can be described as follows:

r₁=\sqrt{r₀²d²+2dr₀ cos φ₀}

If it is assumed that the offset between the transformation centre O₁ and the centre of the coin O₀ is much smaller than the radius of the coin r₀ (d<<r₀), then the difference between the phase angles is also small:

φ₁≈φ₀

The above equation can be transformed as follows:

$${r}_{1} \approx {r}_{0} ( 1 + \frac{d}{{r}_{0}} cos {φ}_{1} )$$

or if only variations of the distance are considered

r₁−r₀≈d cos φ₁

It is thus clear that, at least in the case of a small offset between the centre of the coin and the centre of the transformation in comparison with the radius of the coin, variations in the edge line in the transformed image by a value r₀ can be described in fact with a sine function (or cosine function).

However the greater the offset between the centres, the further the edge curve deviates from a sine function. From illustration FIG. 5, it is clear for example that the angle region φₚₒₛ, where r₁ is >r₀ (part of the edge line of D towards C in anticlockwise direction), is smaller than the angle region φ_{neg}, where r₁ is <r₀, and the greater the offset d is, the greater also is the difference between the angle regions and this is termed an “approximately sinusoidal line”.

According to a development which is effected in the clockwise direction and begins with a starting phase angle which is Φ=0°, the amplitude is examined for the sinusoidal line with reference to FIG. 2b and in fact in such a manner that the maximum or the minimum of the amplitude and also the relevant phase angle are found. This takes place by comparison of the difference of the coordinate values on the sinusoidal line 5 at prescribed distances starting from the starting angle.

From the ordinate of the maximum Aₘₐₓ, the ordinate of the minimum Aₘᵢₙ and the phase angles thereof, both the exact radius R_{M} of the coin and the size of the deviation or of the offset of the probable centre from the exact centre δR and the phase angle δΦ of the offset can be calculated in order to bring the centre of the transformation into the exact centre of the coin.

$$δ R = \frac{{A}_{max} - {A}_{min}}{2}$$

$$δ Φ = \frac{{Φ}_{max} + {{Φ}^{′}}_{min}}{2}$$

$${R}_{M} = {R}_{1} + \frac{{A}_{max} + {A}_{min}}{2}$$

Φ′ₘᵢₙ being the phase angle in the counter-direction to the minimum. With reference to FIG. 2b, Φ′ₘᵢₙ can be calculated for example as follows, Φ′ₘᵢₙ=Φ′ₘᵢₙ+π, the angle being calculated in radians. R₁ here is the inner radius of the edge region (see FIGS. 1 and 2).

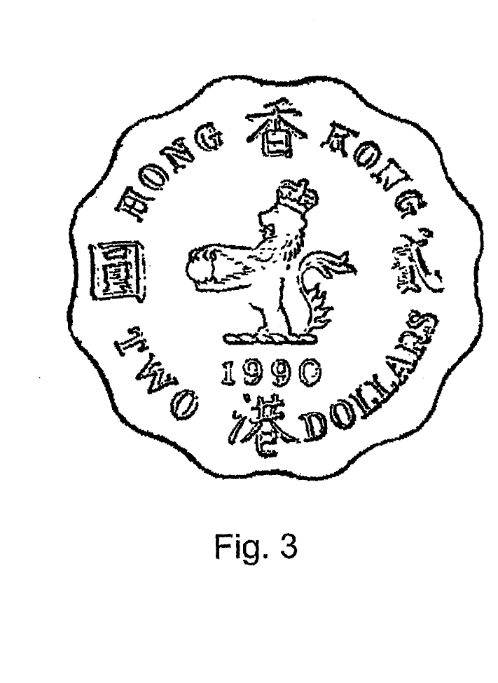

The method according to the invention can also be applied with coins which have a non-round contour but are provided with corners or undulations. Such a coin is represented for example in FIG. 3.

FIG. 4 shows in turn the development of the edge region of the coin according to FIG. 3, FIG. 4a displaying the development around the exact centre, i.e. the development in the case of correspondence of the centres of the transformation and of the centre of the coin, whereas FIG. 4b shows a development around the probable, displaced centre. As can be detected in FIG. 4, the edge curve has repeating maxima and minima, the period P thereof representing the number of undulations and the amplitude between maxima and minima the depth T of the contour.

In FIG. 4b, the edge curve corresponding to FIG. 4a and a sinusoidal line overlap, an average value filter being used to determine the offset of the probable centre from the exact centre, with which average value filter an adjusted smooth curve can be calculated. The maximum and minimum and the phase angles are determined in an analogous manner, as described above, in order to determine the size and direction of the deviation of the probable centre from the exact centre.

For determination of the number of undulations, the depth T thereof and the period P, the current edge line (FIG. 4b) or the number of transitions of the current edge line through the adjusted line can be used.

As an example, method steps are intended to be cited in the following in order to calculate the exact centre and exact radius of an introduced coin:

a) Original image of a coin is subjected to a polar transformation, previous knowledge with respect to probable radius and centre of the coin being thereby used to delimit the transformation region. In practice, it is possible to convert the relevant regions around the edge line of the coin on an original image of the size 400×600 pixels into a transformed image of the size approx. 40×60 pixels (i.e. reduction of the data quantity by the factor 100) which nevertheless contains all the relevant information.
b) In the transformed image, the edge line is sought, the position of the first maximum which exceeds a prescribed threshold (background) is recorded for this for example in each column from top to bottom.
c) Edge line is cleaned (freak values deleted) and balanced. In order to record undulations and corners of the edge in the case of “angular” coins (FIGS. 3+4), two different adjusted copies of the edge line are produced. For example an adjusted edge curve can be produced by a one-dimensional average value filter of the size 3 pixels, and a further copy of the edge curve by a substantially greater average value filter (e.g. of the size 15 pixels). Then by comparison of the slightly and greatly adjusted edge lines, the information about the number and form of the corners can be obtained (see illustrations FIGS. 3+4).
d) Maximum and minimum of the adjusted edge line are calculated and then the sought parameters (centre and radius) are found.

Points b) and c) can be produced with different known methods, therefore they are not dealt with in more detail.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for determining an exact centre of a coin introduced into a coin acceptor unit, method comprising:
determining a probable centre of the coin by means of a sensor arrangement;
recording an image of the coin to be examined; and
developing an edge region of the coin around the probable centre and beyond a probable edge thereof using the image of the coin, the edge region of the coin being imaged as an at least approximately sinusoidal line upon displacement of the probable centre to the exact centre, and the exact centre being determined from analysis of the at least approximately sinusoidal line using an amplitude and phase angle of a chosen starting point.

2. The method according to claim 1, wherein a deviation between the probable centre and the exact centre is determined from half a difference of greatest and smallest amplitudes of the at least approximately sinusoidal line.

3. The method according to claim 1, wherein a direction of deviation between the probable centre and the exact centre is determined from an average of a location of a greatest amplitude and of a location of a smallest amplitude, offset by a half period, of phase angles indicating the at least approximately sinusoidal line.

4. The method according to claim 1, wherein in the case of an edge contour of a coin provided with corners or undulations, the at least approximately sinusoidal line is overlapped by a curve representing the corners or undulations and an average value filter is used to determine the at least approximately sinusoidal line.

5. The method according to claim 4, wherein a number of corners or undulations is determined by a number of maxima and/or minima of the entire line relative to the filtered approximately sinusoidal line.

6. The method according to claim 1, wherein a greatest amplitude of the sinusoidal line relative to a boundary line of the development region is determined, and the exact centre is determined using a difference of a value of the greatest amplitude and of a value of an amplitude of the sinusoidal line relative to the boundary line at a phase angle −90°.

7. The method according to claim 1, wherein an exact radius of the coin is determined from a sum of a radius of an inner boundary line of the edge region and half a sum of the greatest and smallest amplitudes of the at least approximate sinusoidal line.
